(19) United States
(12) Patent Application Publication
(10) Pub. No.: US 2022/0295479 A1
(43) Pub. Date: Sep. 15, 2022

(54) RESOLVING PHYSICAL UPLINK CONTROL CHANNEL COLLISIONS IN SUBSLOTS

(71) Applicant: Telefonaktiebolaget LM Ericsson (publ), Stockholm (SE)

(72) Inventors: Ali BEHRAVAN, Stockholm (SE); Majid GERAMI, Lund (SE); Sorour FALAHATI, Stockholm (SE); Bikramjit SINGH, Kirkkonummi (FI); Yufei BLANKENSHIP, Kildeer, IL (US); Robert BALDEMAIR, Solna (SE)

(21) Appl. No.: 17/633,852

(22) PCT Filed: Aug. 6, 2020
(86) PCT No.: PCT/EP2020/072159

§ 371 Date: Feb. 8, 2022

Related U.S. Application Data
(60) Provisional application No. 62/885,030, filed on Aug. 9, 2019.

(51) Int. Cl. H04W 72/04

(52) U.S. Cl. CPC H04W 72/0446; H04W 72/0406

(57) ABSTRACT

A method, network node and wireless device for resolving physical uplink control channel (PUCCH) collisions in subslots. According to one aspect, a wireless device (WD) is configured to remove a candidate physical uplink control channel, PUCCH, resource from a subslot to resolve an overlap of PUCCH resources in a slot. According to another aspect, a network node is configured to receive a physical uplink control channel, PUCCH, transmission, a PUCCH resource used for the PUCCH transmission being based at least in part on a removal of a candidate PUCCH resource from a subslot to resolve an overlap of PUCCH resources in a slot.

### TECHNICAL FIELD

The present disclosure relates to wireless communication and in particular, to resolving physical uplink control channel (PUCCH) collisions in subslots.

### BACKGROUND

The New radio (NR) (also known as “5G”) standard specified by the 3^{rd} Generation Partnership Project (3GPP) is designed to provide service for multiple use cases such as enhanced mobile broadband (eMBB), ultra-reliable and low latency communication (URLLC), and machine type communication (MTC). Each of these services has different technical requirements. For example, the general requirement for eMBB is high data rate with moderate latency and moderate coverage, while URLLC service requires a low latency and high reliability transmission but perhaps for moderate data rates.

One of the solutions for low latency data transmission is shorter transmission time intervals. In NR, in addition to transmission in a slot, a mini-slot transmission is also allowed to reduce latency. A mini-slot is a concept that is used in scheduling and in downlink (DL) a min-slot can consist of 2, 4 or 7, while in uplink (UL) a mini-slot can be any number of 1 to 14 orthogonal frequency division multiplexed (OFDM) symbols. It should be noted that the concepts of slot and mini-slot are not specific to a specific service meaning that a mini-slot may be used for either eMBB, URLLC, or other services. FIG. 1 shows an exemplary radio resource in NR with subcarrier spacing of 15 kHz.

Uplink control information (UCI) is carried either by physical uplink control channel (PUCCH) or physical uplink shared channel (PUSCH). It contains one or several uplink control information fields, i.e., DL acknowledgement (ACK/NACK), channel quality indicator (CQI) or scheduling request (SR).

UCI is transmitted either on PUSCH if the WD transmits user data in the UL. In this case PUCCH is not allowed to be transmitted. When there is no user data to be transmitted, UCI is carried by PUCCH.

The procedure for receiving downlink transmission is that the WD first monitors and decodes a PDCCH in slot n which points to a DL data unit scheduled in slot n+K₀ slots (K₀ is larger than or equal to 0). The WD then decodes the data in the corresponding physical downlink shared channel (PDSCH). Finally based on the outcome of the decoding, the WD sends an acknowledgement of the correct decoding (ACK) or a negative acknowledgement (NACK) to the network node, e.g., gNB, at time slot n+K₀+K₁. Both of K₀ and K₁ are indicated in the downlink control information (DCI). The resources for sending the acknowledgement are indicated by the PUCCH resource indicator (PRI) field in the PDCCH which points to one of the PUCCH resources that is configured by higher layers. Depending on DL/UL slot configurations, or whether carrier aggregation, or per code-block group (CBG) transmission used in the DL, the feedback for several PDSCHs may need to be multiplexed in one feedback. This is done by constructing HARQ-ACK codebooks.

In Release-16 (Rel-16) of the 3GPP, to allow faster HARQ-ACK feedback, multiple PUCCHs that carry hybrid automatic repeat request (HARQ)-ACK are allowed in a slot. Every slot is divided into multiple subslots, and at most, one PUCCH that carries HARQ ACK may start within each subslot. FIG. 2 shows an example of HARQ-ACK transmission subslots.

There can be a collision between two PUCCHs or a PUCCH and a PUSCH in a slot. In 3GPP Release 15 Rel-15 there are predefined rules for resolving the collision between multiple PUCCHs or PUCCH and PUSCH. The rules are in general based on multiplexing of UCI in a single PUCCH or a PUSCH resource. Timeline requirements for UCI multiplexing are defined that should be met for multiplexing to be expected by a WD. However, 3GPP Rel-15 does not support in general different priority in the physical (PHY) channel between different UCI types. In 3GPP Rel-16 physical channels (e.g. PUSCH, PUCCH) may have different priority levels due to different types of services that they carry.

As explained above, when two PUCCHs overlap in time the general solution in 3GPP Rel-15 is to multiplex the PUCCHs into a new PUCCH. However, in 3GPP Rel-16, since there can be multiple subslots and each contain a HARQ-ACK, there might be cases that multiplexing of PUCCHs into a new PUCCH in a subslot, following the 3GPP Rel-15 procedures for resolving overlapping among PUCCH resources, collides with another PUCCH in the next subslot (if the selected PUCCH resource stretches into the next subslot). This is illustrated by FIG. 3, where PUCCH1 and PUCCH2 overlap and are multiplexed into a new PUCCH1+PUCCH2, but then this collides with PUCCH3 in the next subslot.

### SUMMARY

Some embodiments advantageously provide methods, systems, and apparatuses for resolving physical uplink control channel (PUCCH) collisions in subslots.

Methods to resolve collision between PUCCHs of different subslots are presented. More specifically, some embodiments provide at least:
a) PUCCH resources configured such that they do not overlap;
b) Resolution for overlapping PUCCHs in a first subslot. As such, PUCCH resources from the next subslot that collide with the PUCCH that is selected in the first subslot are not considered from the candidate PUCCHs that can be used in the next subslot for resolving overlapping.

Some of the methods presented herein allow transmission of multiple PUCCHs in a slot without the risk of overlapping with a PUCCH from the next subslot.

According to an aspect of the present disclosure, a method implemented in a wireless device, WD, is provided. The method includes removing a candidate physical uplink control channel, PUCCH, resource from a subslot to resolve an overlap of PUCCH resources in a slot.

In some embodiments of this aspect, the candidate PUCCH resource extends from the subslot to a next subslot and removing the candidate PUCCH resource comprises removing the candidate PUCCH resource that extends from the subslot to the next subslot. In some embodiments of this aspect, the candidate PUCCH resource extends from a next subslot and overlaps with a PUCCH extending from a first subslot to the next subslot and removing the candidate PUCCH resource comprises removing the candidate PUCCH resource extending from the next subslot that overlaps with the PUCCH extending from the first subslot to the next subslot.

In some embodiments of this aspect, the method further comprises selecting a PUCCH resource to transmit at least one uplink control information, UCI, message in a first subslot; and the candidate PUCCH resource extends from a next subslot and removing the candidate PUCCH resource comprises removing the candidate PUCCH resource extending from the next subslot based at least in part on the PUCCH resource selected in the first subslot. In some embodiments of this aspect, removing the candidate PUCCH resource comprises removing the candidate PUCCH resource extending from the next subslot that overlaps with the selected PUCCH resource in the first subslot. In some embodiments of this aspect, each PUCCH resource is configured to be within a single subslot.

In some embodiments of this aspect, the method further includes determining whether a WD processing timeline for an uplink control information, UCI, message multiplexing with a physical uplink shared channel, PUSCH, is satisfied, the resolution of the overlap being based at least in part on the determination. In some embodiments of this aspect, the method includes, based at least in part on the determination, multiplexing the UCI message on a physical uplink shared channel, PUSCH. In some embodiments of this aspect, the method includes, based at least in part on the determination, retaining a latter one of the PUSCH and the UCI message for transmission and discarding an earlier one of the PUSCH and the UCI message. In some embodiments of this aspect, the method includes, based at least in part on the determination, retaining a one of the PUSCH and UCI for transmission having a first priority and discarding the other one of the PUSCH and UCI message having a priority lower than the first priority.

In some embodiments of this aspect, an uplink control information, UCI, message with a first priority is retained for transmission and a UCI message having a priority lower than the first priority is discarded. In some embodiments of this aspect, the resolution of the overlap being based at least in part on a relative priority associated with each uplink control information, UCI, message to be transmitted in the overlapping PUCCH resources in the slot and a utility maximization function.

According to another aspect of the present disclosure, a method implemented in a network node is provided. The method includes receiving a physical uplink control channel, PUCCH, transmission, a PUCCH resource used for the PUCCH transmission being based at least in part on a removal of a candidate PUCCH resource from a subslot to resolve an overlap of PUCCH resources in a slot.

In some embodiments of this aspect, the PUCCH resource used for the PUCCH transmission is based at least in part on a removal of the candidate PUCCH resource extending from a first subslot to a next subslot. In some embodiments of this aspect, the PUCCH resource used for the PUCCH transmission is based at least in part on a removal of the candidate PUCCH resource extending from a next subslot that overlaps with a PUCCH extending from a first subslot to the next subslot. In some embodiments of this aspect, the PUCCH resource used for the PUCCH transmission is based at least in part on a removal of the candidate PUCCH resource extending from a next subslot based at least in part on a PUCCH resource selection in a first subslot.

In some embodiments of this aspect, the PUCCH resource used for the PUCCH transmission is based at least in part on a removal of the candidate PUCCH resource extending from a next subslot that overlaps with a selected PUCCH resource in a first subslot. In some embodiments of this aspect, each PUCCH resource is configured to be within a single subslot.

In some embodiments of this aspect, the PUCCH resource used for the PUCCH transmission is based at least in part on whether a wireless device, WD, processing timeline for an uplink control information, UCI, message multiplexing with a physical uplink shared channel, PUSCH, is satisfied. In some embodiments of this aspect, based at least in part on whether the WD processing timeline for the UCI message multiplexing with the PUSCH is satisfied, receiving the PUCCH transmission as the UCI message being multiplexed on a physical uplink shared channel, PUSCH. In some embodiments of this aspect, based at least in part on whether the WD processing timeline for the UCI message multiplexing with the PUSCH is satisfied, receiving the PUCCH transmission as a latter one of the PUSCH and the UCI message being retained for the transmission and an earlier one of the PUSCH and the UCI message being discarded. In some embodiments of this aspect, based at least in part on whether the WD processing timeline for the UCI message multiplexing with the PUSCH is satisfied, receiving the PUCCH transmission as a one of the PUSCH and UCI being retained for the transmission having a first priority and the other one of the PUSCH and UCI message having a priority lower than the first priority being discarded.

In some embodiments of this aspect, an uplink control information, UCI, message with a first priority is retained for the PUCCH transmission and a UCI message having a priority lower than the first priority is discarded. In some embodiments of this aspect, receiving the PUCCH transmission is based at least in part on a relative priority associated with each uplink control information, UCI, message to be transmitted in an overlapping PUCCH resource in the slot and a utility maximization function.

According to yet another aspect of the present disclosure, a wireless device, WD, configured to communicate with a network node is provided. The wireless device comprises processing circuitry. The processing circuitry is configured to cause the wireless device to remove a candidate physical uplink control channel, PUCCH, resource from a subslot to resolve an overlap of PUCCH resources in a slot.

In some embodiments of this aspect, the candidate PUCCH resource extends from the subslot to a next subslot and the processing circuitry is configured to cause the wireless device to remove the candidate PUCCH resource by being configured to cause the wireless device to remove the candidate PUCCH resource that extends from the subslot to the next subslot. In some embodiments of this aspect, the candidate PUCCH resource extends from a next subslot and overlaps with a PUCCH extending from a first subslot to the next subslot and the processing circuitry is configured to cause the wireless device to remove the candidate PUCCH resource by being configured to cause the wireless device to remove the candidate PUCCH resource extending from the next subslot that overlaps with the PUCCH extending from the first subslot to the next subslot.

In some embodiments of this aspect, the processing circuitry is further configured to select a PUCCH resource to transmit at least one uplink control information, UCI, message in a first subslot; and the candidate PUCCH resource extends from a next subslot; and the processing circuitry is configured to cause the wireless device to remove the candidate PUCCH resource by being configured to cause the wireless device to remove the candidate PUCCH resource extending from the next subslot based at least in part on the PUCCH resource selected in the first subslot.

In some embodiments of this aspect, the processing circuitry is further configured to cause the wireless device to remove the candidate PUCCH resource extending from the next subslot that overlaps with the selected PUCCH resource in the first subslot. In some embodiments of this aspect, each PUCCH resource is configured to be within a single subslot.

In some embodiments of this aspect, the processing circuitry is further configured to cause the wireless device to determine whether a WD processing timeline for an uplink control information, UCI, message multiplexing with a physical uplink shared channel, PUSCH, is satisfied, the resolution of the overlap being based at least in part on the determination. In some embodiments of this aspect, the processing circuitry is further configured to cause the wireless device to, based at least in part on the determination, multiplex the UCI message on a physical uplink shared channel, PUSCH. In some embodiments of this aspect, based at least in part on the determination, retain a latter one of the PUSCH and the UCI message for transmission and discard an earlier one of the PUSCH and the UCI message. In some embodiments of this aspect, based at least in part on the determination, retain a one of the PUSCH and UCI for transmission having a first priority and discard the other one of the PUSCH and UCI message having a priority lower than the first priority.

In some embodiments of this aspect, an uplink control information, UCI, message with a first priority is retained for transmission and a UCI message having a priority lower than the first priority is discarded. In some embodiments of this aspect, the resolution of the overlap being based at least in part on a relative priority associated with each uplink control information, UCI, message to be transmitted in the overlapping PUCCH resources in the slot and a utility maximization function.

According to another aspect of the present disclosure, a network node configured to communicate with a wireless device, WD, is provided. The network node includes processing circuitry. The processing circuitry is configured to cause the network node to receive a physical uplink control channel, PUCCH, transmission, a PUCCH resource used for the PUCCH transmission being based at least in part on a removal of a candidate PUCCH resource from a subslot to resolve an overlap of PUCCH resources in a slot.

In some embodiments of this aspect, the PUCCH resource used for the PUCCH transmission is based at least in part on a removal of the candidate PUCCH resource extending from a first subslot to a next subslot. In some embodiments of this aspect, the PUCCH resource used for the PUCCH transmission is based at least in part on a removal of the candidate PUCCH resource extending from a next subslot that overlaps with a PUCCH extending from a first subslot to the next subslot. In some embodiments of this aspect, the PUCCH resource used for the PUCCH transmission is based at least in part on a removal of the candidate PUCCH resource extending from a next subslot based at least in part on a PUCCH resource selection in a first subslot. In some embodiments of this aspect, the PUCCH resource used for the PUCCH transmission is based at least in part on a removal of the candidate PUCCH resource extending from a next subslot that overlaps with a selected PUCCH resource in a first subslot. In some embodiments of this aspect, each PUCCH resource is configured to be within a single subslot.

In some embodiments of this aspect, the PUCCH resource used for the PUCCH transmission is based at least in part on whether a wireless device, WD, processing timeline for an uplink control information, UCI, message multiplexing with a physical uplink shared channel, PUSCH, is satisfied. In some embodiments of this aspect, based at least in part on whether the WD processing timeline for the UCI message multiplexing with the PUSCH is satisfied, the processing circuitry is configured to cause the network node to receive the PUCCH transmission as one of: the UCI message being multiplexed on a physical uplink shared channel, PUSCH; a latter one of the PUSCH and the UCI message being retained for the transmission and an earlier one of the PUSCH and the UCI message being discarded; and a one of the PUSCH and UCI being retained for the transmission having a first priority and the other one of the PUSCH and UCI message having a priority lower than the first priority being discarded.

In some embodiments of this aspect, an uplink control information, UCI, message with a first priority is retained for the PUCCH transmission and a UCI message having a priority lower than the first priority is discarded. In some embodiments of this aspect, the processing circuitry is configured to cause the network node to receive the PUCCH transmission based at least in part on a relative priority associated with each uplink control information, UCI, message to be transmitted in an overlapping PUCCH resource in the slot and a utility maximization function.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is an exemplary radio resource in NR with subcarrier spacing of 15 kHz;

FIG. 2 is an example of HARQ-ACK transmission subslots;

FIG. 3 shows a collision with a PUCCH in a next subslot;

FIG. 4 is a schematic diagram of an exemplary network architecture illustrating a communication system connected via an intermediate network to a host computer according to the principles in the present disclosure;

FIG. 5 is a block diagram of a host computer communicating via a network node with a wireless device over an at least partially wireless connection according to some embodiments of the present disclosure;

FIG. 6 is a flowchart illustrating exemplary methods implemented in a communication system including a host computer, a network node and a wireless device for executing a client application at a wireless device according to some embodiments of the present disclosure;

FIG. 7 is a flowchart illustrating exemplary methods implemented in a communication system including a host computer, a network node and a wireless device for receiving user data at a wireless device according to some embodiments of the present disclosure;

FIG. 8 is a flowchart illustrating exemplary methods implemented in a communication system including a host computer, a network node and a wireless device for receiving user data from the wireless device at a host computer according to some embodiments of the present disclosure;

FIG. 9 is a flowchart illustrating exemplary methods implemented in a communication system including a host computer, a network node and a wireless device for receiving user data at a host computer according to some embodiments of the present disclosure;

FIG. 10 is a flowchart of an exemplary process in a network node according to some embodiments of the present disclosure;

FIG. 11 is a flowchart of an exemplary process in a wireless device according to some embodiments of the present disclosure;

FIG. 12 illustrates removing candidate PUCCH resources from the earlier subslot that extend to the next subslot and collide with another candidate PUCCH resource;

FIG. 13 illustrates removing candidate PUCCH resources in the next subslot that overlaps with a PUCCH resource that extends from the earlier subslot;

FIG. 14 illustrates an example with two subslots in a slot;

FIG. 15 illustrates the framework for resolving overlapping PUCCH/PUSCH in a subslot;

FIG. 16 illustrates a procedure for a checking timeline for UCI multiplexing in a subslot.

FIG. 17 is an example of timing criteria for implementing some embodiments;

FIG. 18 is another example of timing criteria for implementing some embodiments; and

FIG. 19 is an example of a WD resolving conflict between messages.

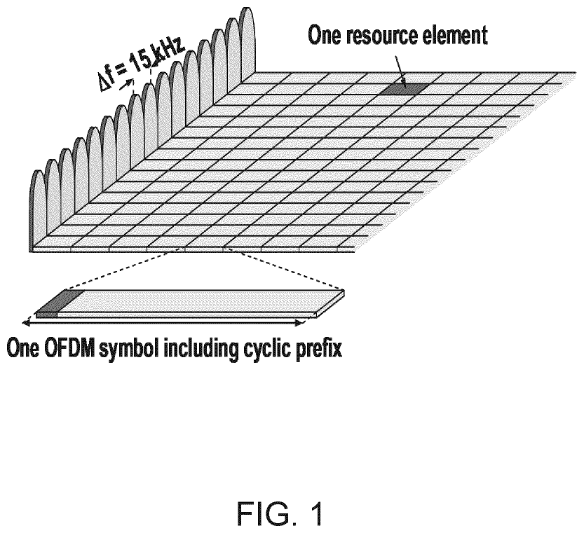

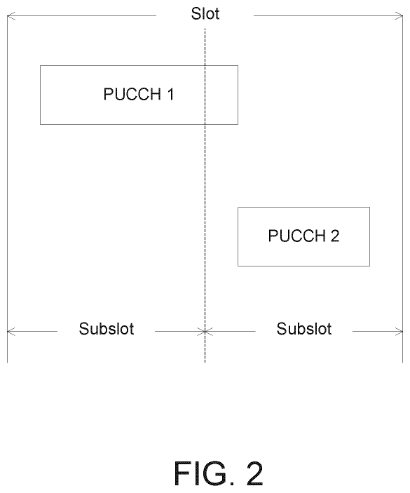

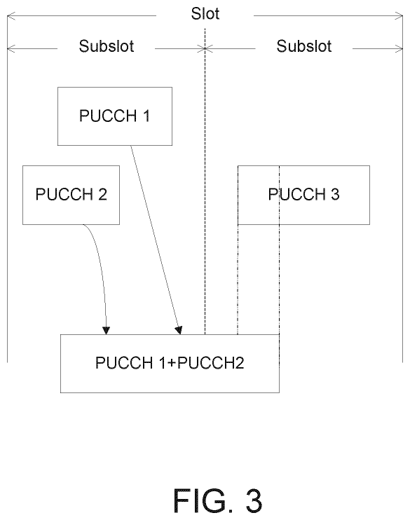

### DETAILED DESCRIPTION

Before describing in detail exemplary embodiments, it is noted that the embodiments reside primarily in combinations of apparatus components and processing steps related to resolving physical uplink control channel (PUCCH) collisions in subslots. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, integrated access and backhaul (IAB) node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide for resolving physical uplink control channel (PUCCH) collisions in subslots. In some embodiments, it may be assumed that the overlapping between PUCCH resources with earlier starting symbols are intended to be resolved first, until there is no overlapping PUCCH resource in a slot. In some of the embodiments below, two subslots are considered for simplicity. However, the procedures may be applicable to more subslots if available.

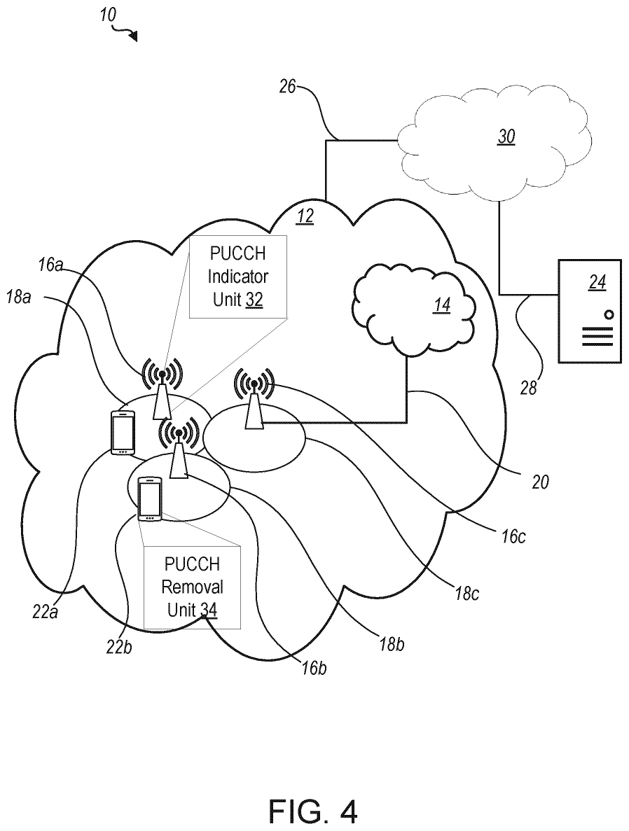

Returning now to the drawing figures, in which like elements are referred to by like reference numerals, there is shown in FIG. 4 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 4 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a PUCCH indicator unit 32 which is configured to receive a physical uplink control channel, PUCCH, transmission, a PUCCH resource used for the PUCCH transmission being based at least in part on a removal of a candidate PUCCH resource from a subslot to resolve an overlap of PUCCH resources in a slot. In some embodiments, the PUCCH indicator unit 32 is configured to signal a PUCCH resource indicator in a downlink control information, DCI, message so that a new PUCCH resource does not overlap with another PUCCH resource.

A wireless device 22 is configured to include a PUCCH removal unit 34 which is configured to remove a candidate physical uplink control channel, PUCCH, resource from a subslot to resolve an overlap of PUCCH resources in a slot. In some embodiments, the PUCCH removal unit 34 is configured to remove a candidate physical uplink control channel, PUCCH, resource from a first subslot that extends to a next subslot, or alternatively, remove a candidate physical uplink control channel, PUCCH, resource from the next sublot that overlaps with a PUCCH extending from the first subslot to the next subslot.

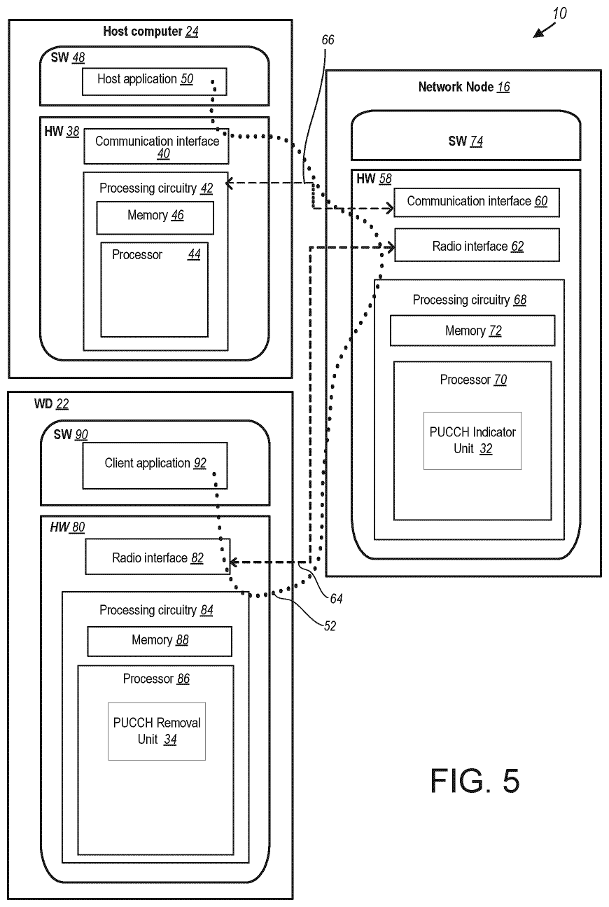

Example implementations, in accordance with an embodiment, of the WD 22, network node 16 and host computer 24 discussed in the preceding paragraphs will now be described with reference to FIG. 5. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a PUCCH indicator unit 32 which is configured to signal a PUCCH resource indicator in a downlink control information, DCI, message so that a new PUCCH resource does not overlap with another PUCCH resource.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a PUCCH removal unit 34 which is configured to remove a candidate physical uplink control channel, PUCCH, resource from a first subslot that extends to a next subslot, or alternatively, remove a candidate physical uplink control channel, PUCCH, resource from the next sublot that overlaps with a PUCCH extending from the first subslot to the next subslot.

In some embodiments, the inner workings of the network node 16, WD 22, and host computer 24 may be as shown in FIG. 5 and independently, the surrounding network topology may be that of FIG. 4.

In FIG. 5, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for

preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for

preparing/initiating/maintaining/supporting/ending a transmission to the network node 16, and/or preparing/terminating/maintaining/supporting/ending in receipt of a transmission from the network node 16.

Although FIGS. 4 and 5 show various “units” such as PUCCH indicator unit 32, and PUCCH removal unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

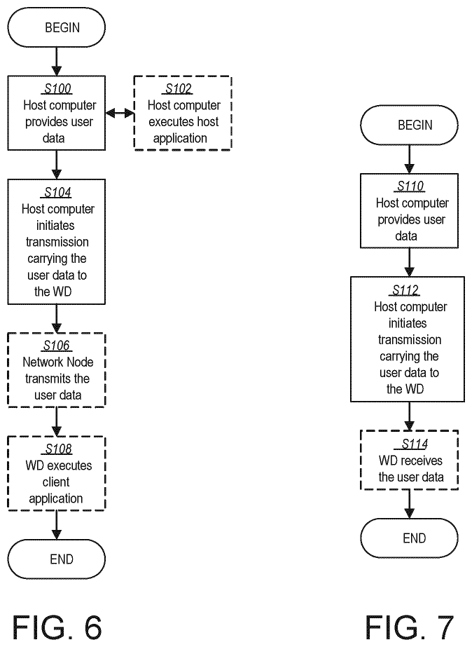

FIG. 6 is a flowchart illustrating an exemplary method implemented in a communication system, such as, for example, the communication system of FIGS. 4 and 5, in accordance with one embodiment. The communication system may include a host computer 24, a network node 16 and a WD 22, which may be those described with reference to FIG. 5. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 7 is a flowchart illustrating an exemplary method implemented in a communication system, such as, for example, the communication system of FIG. 4, in accordance with one embodiment. The communication system may include a host computer 24, a network node 16 and a WD 22, which may be those described with reference to FIGS. 4 and 5. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

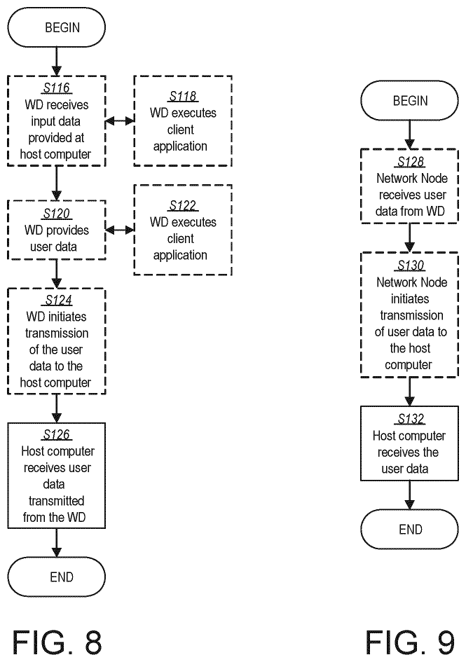

FIG. 8 is a flowchart illustrating an exemplary method implemented in a communication system, such as, for example, the communication system of FIG. 4, in accordance with one embodiment. The communication system may include a host computer 24, a network node 16 and a WD 22, which may be those described with reference to FIGS. 4 and 5. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 9 is a flowchart illustrating an exemplary method implemented in a communication system, such as, for example, the communication system of FIG. 4, in accordance with one embodiment. The communication system may include a host computer 24, a network node 16 and a WD 22, which may be those described with reference to FIGS. 4 and 5. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

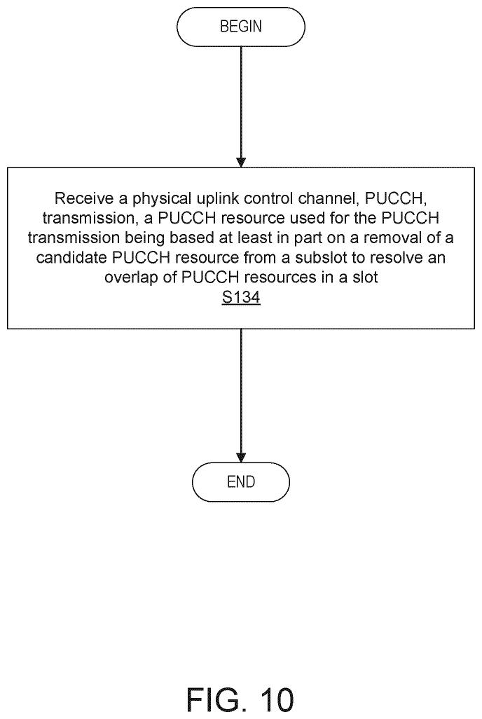

FIG. 10 is a flowchart of an exemplary process in a network node 16 according to some embodiments presented herein. One or more blocks described herein may be performed by one or more elements of network node 16 such as by one or more of processing circuitry 68 (including the PUCCH Indicator Unit 32) processor 70, radio interface 62 and/or communication interface 60. Network node 16 such as via processing circuitry 68 and/or processor 70 and/or radio interface 62 and/or communication interface 60 is configured to receive (Block S134) a physical uplink control channel, PUCCH, transmission, a PUCCH resource used for the PUCCH transmission being based at least in part on a removal of a candidate PUCCH resource from a subslot to resolve an overlap of PUCCH resources in a slot.

In some embodiments, the PUCCH resource used for the PUCCH transmission is based at least in part on a removal of the candidate PUCCH resource extending from a first subslot to a next subslot. In some embodiments, the PUCCH resource used for the PUCCH transmission is based at least in part on a removal of the candidate PUCCH resource extending from a next subslot that overlaps with a PUCCH extending from a first subslot to the next subslot. In some embodiments, the PUCCH resource used for the PUCCH transmission is based at least in part on a removal of the candidate PUCCH resource extending from a next subslot based at least in part on a PUCCH resource selection in a first subslot.

In some embodiments, the PUCCH resource used for the PUCCH transmission is based at least in part on a removal of the candidate PUCCH resource extending from a next subslot that overlaps with a selected PUCCH resource in a first subslot. In some embodiments, each PUCCH resource is configured to be within a single subslot. In some embodiments, the PUCCH resource used for the PUCCH transmission is based at least in part on whether a wireless device, WD, processing timeline for an uplink control information, UCI, message multiplexing with a physical uplink shared channel, PUSCH, is satisfied.

In some embodiments, the network node 16 such as via processing circuitry 68 and/or processor 70 and/or radio interface 62 and/or communication interface 60 is configured to one of: based at least in part on whether the WD processing timeline for the UCI message multiplexing with the PUSCH is satisfied, receive the PUCCH transmission as the UCI message being multiplexed on a physical uplink shared channel, PUSCH; based at least in part on whether the WD processing timeline for the UCI message multiplexing with the PUSCH is satisfied, receive the PUCCH transmission as a latter one of the PUSCH and the UCI message being retained for the transmission and an earlier one of the PUSCH and the UCI message being discarded; and based at least in part on whether the WD processing timeline for the UCI message multiplexing with the PUSCH is satisfied, receive the PUCCH transmission as one of the PUSCH and UCI being retained for the transmission having a first priority and the other one of the PUSCH and UCI message having a priority lower than the first priority being discarded.

In some embodiments, an uplink control information, UCI, message with a first priority is retained for the PUCCH transmission and a UCI message having a priority lower than the first priority is discarded. In some embodiments, the processing circuitry is configured to cause the network node to receive the PUCCH transmission based at least in part on a relative priority associated with each uplink control information, UCI, message to be transmitted in an overlapping PUCCH resource in the slot and a utility maximization function.

In some embodiments, the network node 16 such as via processing circuitry 68 and/or processor 70 and/or radio interface 62 and/or communication interface 60 is configured to receive a PUCCH resource from the WD 22. The process includes signaling a PUCCH resource indicator in a downlink control information, DCI, message so that a new PUCCH resource does not overlap with another PUCCH resource.

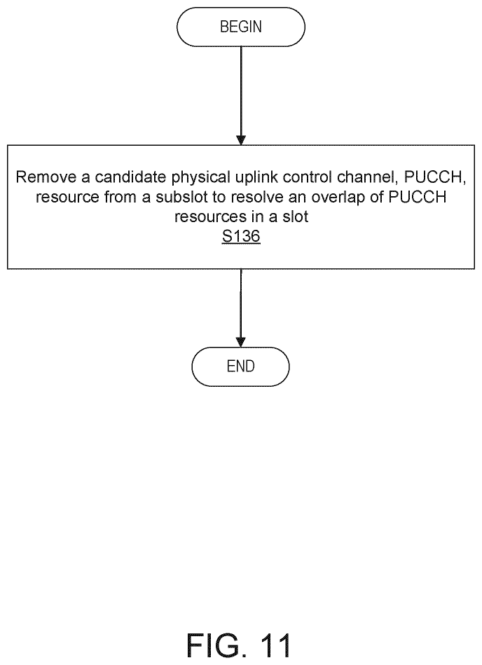

FIG. 11 is a flowchart of an exemplary process in a wireless device 22 according to some embodiments of the present disclosure. One or more blocks described herein may be performed by one or more elements of wireless device 22 such as by one or more of processing circuitry 84 (including the PUCCH Removal Unit 34), processor 86, radio interface 82 and/or communication interface 60. Wireless device 22 such as via processing circuitry 84 and/or processor 86 and/or radio interface 82 is configured to remove (Block S136) a candidate physical uplink control channel, PUCCH, resource from a subslot to resolve an overlap of PUCCH resources in a slot.

In some embodiments, the candidate PUCCH resource extends from the subslot to a next subslot and the wireless device 22 such as via processing circuitry 84 and/or processor 86 and/or radio interface 82 is configured to cause the wireless device 22 to remove the candidate PUCCH resource by being configured to cause the wireless device 22 to remove the candidate PUCCH resource that extends from the subslot to the next subslot. In some embodiments, the candidate PUCCH resource extends from a next subslot and overlaps with a PUCCH extending from a first subslot to the next subslot and the wireless device 22 such as via processing circuitry 84 and/or processor 86 and/or radio interface 82 is configured to cause the wireless device 22 to remove the candidate PUCCH resource by being configured to cause the wireless device 22 to remove the candidate PUCCH resource extending from the next subslot that overlaps with the PUCCH extending from the first subslot to the next subslot.

In some embodiments, the wireless device 22 such as via processing circuitry 84 and/or processor 86 and/or radio interface 82 is further configured to cause the wireless device 22 to select a PUCCH resource to transmit at least one uplink control information, UCI, message in a first subslot; and the candidate PUCCH resource extends from a next subslot; and the wireless device 22 such as via processing circuitry 84 and/or processor 86 and/or radio interface 82 is configured to cause the wireless device 22 to remove the candidate PUCCH resource by being configured to cause the wireless device 22 to remove the candidate PUCCH resource extending from the next subslot based at least in part on the PUCCH resource selected in the first subslot.

In some embodiments, the wireless device 22 such as via processing circuitry 84 and/or processor 86 and/or radio interface 82 is configured to cause the wireless device 22 to remove the candidate PUCCH resource extending from the next subslot that overlaps with the selected PUCCH resource in the first subslot. In some embodiments, each PUCCH resource is configured to be within a single subslot.

In some embodiments, the wireless device 22 such as via processing circuitry 84 and/or processor 86 and/or radio interface 82 is configured to cause the wireless device 22 to determine whether a WD processing timeline for an uplink control information, UCI, message multiplexing with a physical uplink shared channel, PUSCH, is satisfied, the resolution of the overlap being based at least in part on the determination. In some embodiments, the wireless device 22 such as via processing circuitry 84 and/or processor 86 and/or radio interface 82 is configured to cause the wireless device 22 to one of: based at least in part on the determination, multiplex the UCI message on a physical uplink shared channel, PUSCH; based at least in part on the determination, retain a latter one of the PUSCH and the UCI message for transmission and discard an earlier one of the PUSCH and the UCI message; and based at least in part on the determination, retain a one of the PUSCH and UCI for transmission having a first priority and discard the other one of the PUSCH and UCI message having a priority lower than the first priority.

In some embodiments, an uplink control information, UCI, message with a first priority is retained for transmission and a UCI message having a priority lower than the first priority is discarded. In some embodiments, the resolution of the overlap being based at least in part on a relative priority associated with each uplink control information, UCI, message to be transmitted in the overlapping PUCCH resources in the slot and a utility maximization function.

In some embodiments, the wireless device 22 such as via processing circuitry 84 and/or processor 86 and/or radio interface 82 is configured to remove a candidate physical uplink control channel, PUCCH, resource from a first subslot that extends to a next subslot. Alternatively, the process may include removing a candidate physical uplink control channel, PUCCH, resource from the next sublot that overlaps with a PUCCH extending from the first subslot to the next subslot.

Having described the general process flow of arrangements of the disclosure and having provided examples of hardware and software arrangements for implementing the processes and functions of the disclosure, the sections below provide details and examples of arrangements for resolving physical uplink control channel (PUCCH) collisions in subslots.

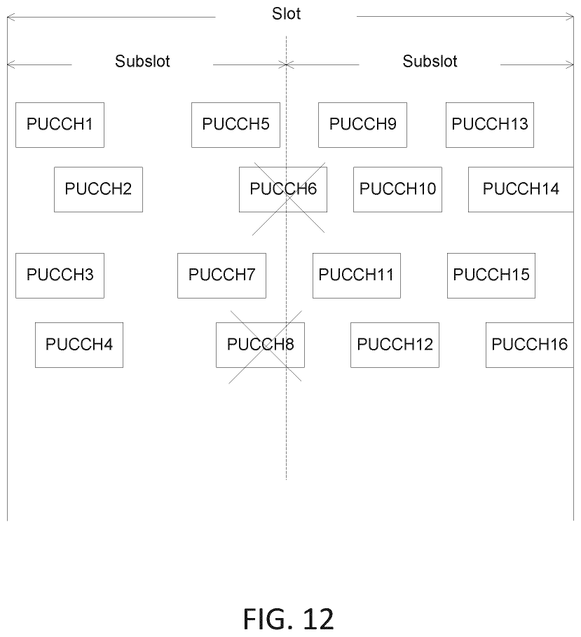

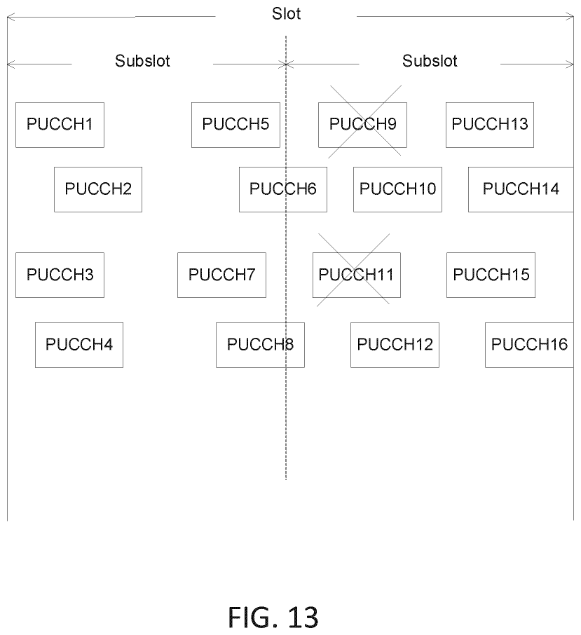

In some embodiments, PUCCH resources that are configured in different subslots for transmission of HARQ ACK are configured such that they do not overlap. This can be done, for example, by either:
c) Removing candidate PUCCH resources from the earlier subslot that extend to the next subslot and collide with another candidate PUCCH resource (see FIG. 12); or
d) removing candidate PUCCH resources in the next subslot that overlaps with a PUCCH resource that extends from the earlier subslot (See FIG. 13).

Note that, in some embodiments, PUCCH resources are limited to a subslot, i.e., they must start and stop in the same subslot. In other words, each PUCCH resource is configured/expected to be within a single subslot.

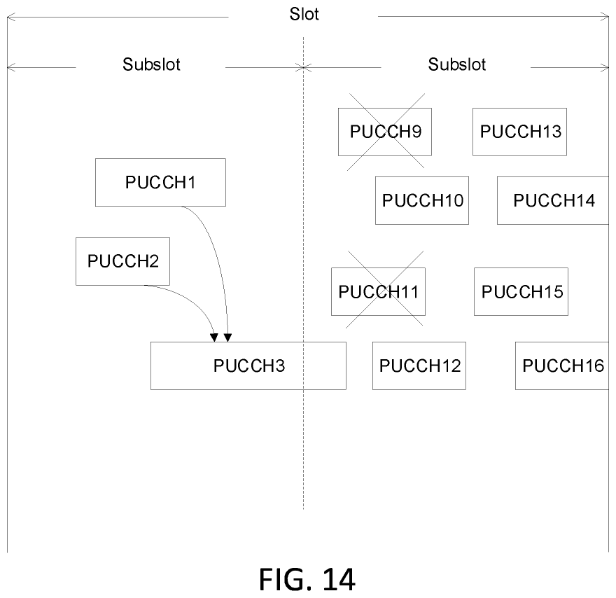

According to another method, overlapping PUCCHs in the first subslot may be resolved and then based on the PUCCH resource(s) that are used for transmission of UCI in the first subslot, all candidate PUCCH resources in the subsequent subslot(s) that overlap with the selected PUCCH resource in the first slot are removed (e.g., by the WD 22) from the set of candidate PUCCH resources in those subslot(s). FIG. 14 illustrates one example with two subslots in a slot. In this example, resolving the overlapping between PUCCH1 and PUCCH2 results in multiplexing the contents of both into PUCCH3. Based on that, in the next subslot, PUCCH9 and PUCCH11 that overlap with PUCCH3 are removed (e.g., by the WD 22) from the candidate PUCCH resources in the next subslot.

In another embodiment, when resolving PUCCH collisions, not only are overlapping PUCCH transmissions in the first subslot considered, but even planned PUCCH transmission(s) in subsequent subslot(s) that overlap with planned PUCCH transmission(s) in the first slot are considered e.g., by the WD 22 and/or the network node 16. Once all collisions are resolved, a PUCCH resource in the first subslot is selected e.g., by the WD 22.

In another embodiment, the PUCCH resource indicator in the DCI corresponding to the overlapping PUCCH resources may be signaled such that a new determined PUCCH resource for the multiplexed UCI corresponding to the overlapping PUCCH resources in a subslot, does not overlap with a PUCCH resource in the next subslot that is intended for UCI transmission, if any.

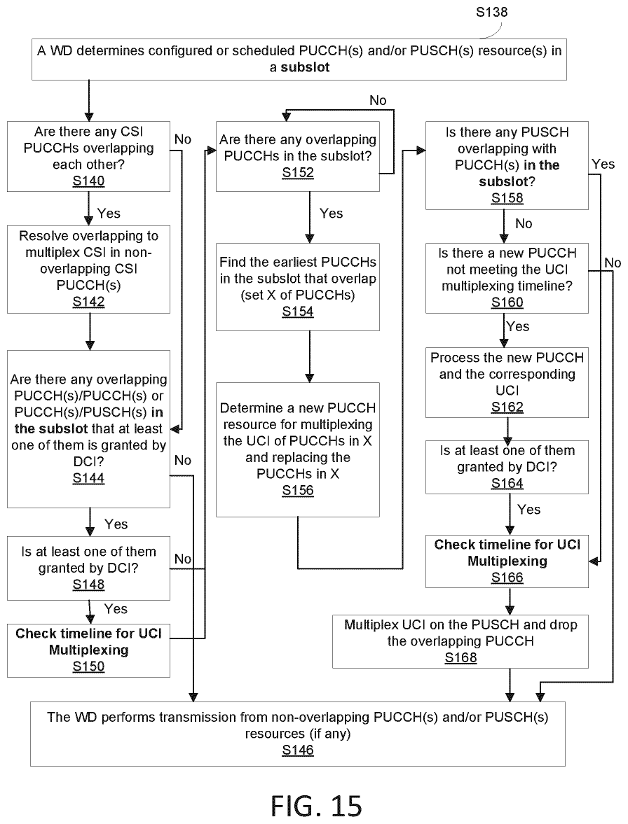

FIG. 15 illustrates an example framework for resolving overlapping PUCCH/PUSCH in a subslot. In step S138, a WD 22 determines, such as via processing circuitry 84, configured or scheduled PUCCH(s) and/or PUSCH(s) resource(s) in a subslot. In step S140, the WD 22 may determine, such as via processing circuitry 84, whether there are any channel state information (CSI) PUCCHs overlapping each other. If the answer is yes, the process may proceed to step S142, where the WD 22 may resolve overlapping to multiplex CSI in non-overlapping CSI PUCCH(s).

In step S144, the WD 22 may determine, such as via processing circuitry 84, whether there are any overlapping PUCCH(s)/PUCCH(s) or PUCCH(s)/PUSCH(s) in the subslot that at least one of them is granted by downlink control information (DCI). If the answer is no, the WD 22 performs transmission, such as via radio interface 82, from non-overlapping PUCCH(s) and/or PUSCH(s) resources, if any. If the answer is yes, the process proceeds to step S148, where the WD 22 may determine if at least one of the overlapping resources is granted by DCI. If yes, the process proceeds to step S150 where the WD 22 checks the timeline for UCI multiplexing. If the answer is no, the process proceeds to step S152, where the WD determines whether there are any overlapping PUCCHs in the subslot. If there are, then the WD 22 may find the earliest PUCCHs in the subslot that overlap (e.g., set X of PUCCHs) in step S154.

In step S156, the WD 22 may determine a new PUCCH resource for multiplexing the UCI of PUCCHs in X and replacing the PUCCHs in X. In step S158, the WD 22 may determine whether there is any PUSCH overlapping with the PUCCH(s) in the subslot. In step S160, the WD 22 may determine whether there is a new PUCCH not meeting the UCI timeline. If the answer is yes (i.e., there is a new

PUCCH not meeting the UCI timeline), the WD 22 may process the new PUCCH and the corresponding UCI in step S162. In step S162, the WD 22 may determine whether there is at least one of them granted by DCI. If there is, the process may proceed to step S166 where the WD 22 checks, such as via processing circuitry 84, the timeline for UCI multiplexing. In step S168, the WD 22 may multiplex the UCI on the PUSCH and drop the overlapping PUCCH.

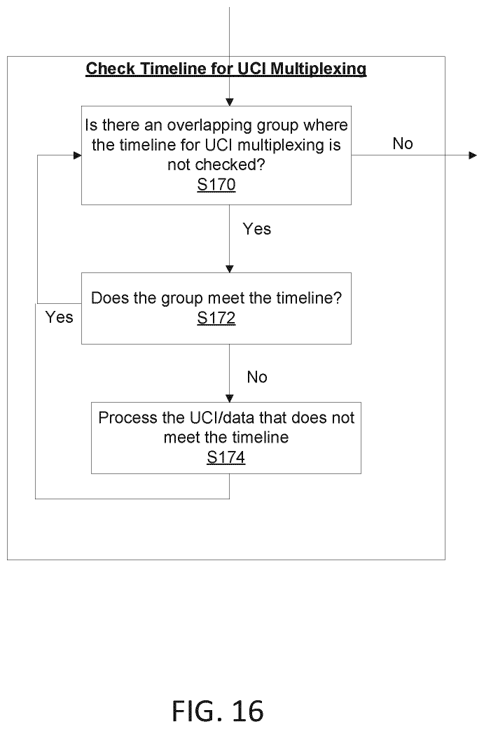

FIG. 16 illustrates a procedure for a checking timeline for UCI multiplexing in a subslot, such as for example in steps S150 or S168 in FIG. 15. In step S170 of FIG. 16, the WD 22 may determine, such as via processing circuitry 84, whether there is an overlapping group where the timeline for UCI multiplexing is not checked. If the answer is yes, in step S172, the WD 22 may determine, such as via processing circuitry 84, whether the group meets the timeline. If the answer is no, i.e., the group does not meet the timeline, in step S174, the WD 22 may process the UCI/data that does not meet the timeline. If the answer is yes, i.e., the group does meet the timeline, the process may return to step S170.

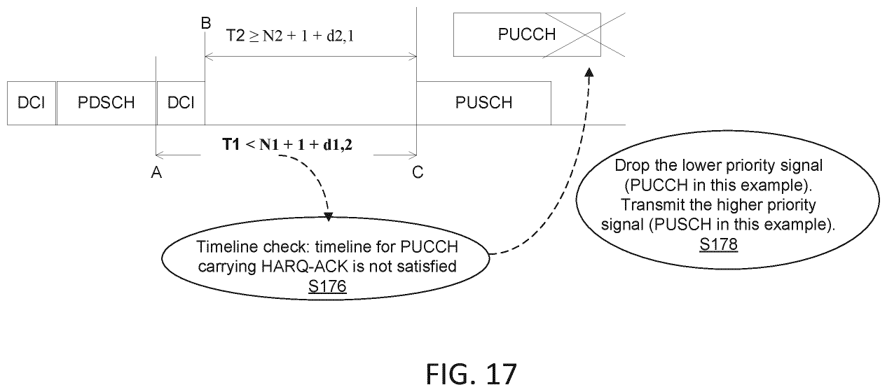

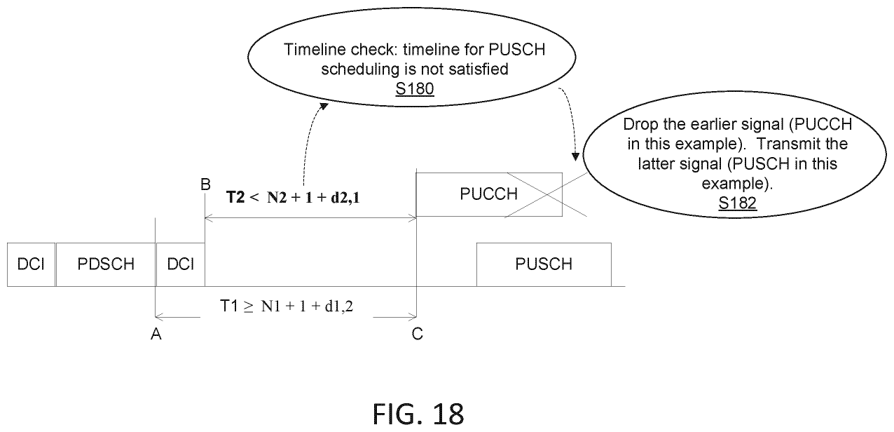

In some embodiments, when the WD 22 processing timeline for UCI multiplexing is not satisfied:
e) in one embodiment, then the PUCCH and/or PUSCH in the group may be an error case and dropped by the WD 22 with corresponding UCI/data.
f) Alternatively, in another embodiment, the UCI and/or data of higher priority may be kept for transmission, while the UCI and/or data of lower priority are dropped by the WD 22. One example is illustrated in FIG. 17. As shown in FIG. 17, the WD 22 may determine, such as via processing circuitry 84, that the timeline for PUCCH carrying a HARQ-ACK is not satisfied in step S176. In step S178, the WD 22 may then drop the lower priority signal (PUCCH in this example) and transmit, such as via radio interface 82, the higher priority signal (PUSCH in this example).
g) Alternatively, in yet another embodiment, the latter UCI and/or data may be kept for transmission, while the earlier UCI and/or data are dropped. The timing criteria for dropping is such that the latter UCI and/or data can be successfully multiplexed with the UCI processing time. One example is illustrated in FIG. 18. As shown in FIG. 18, the WD 22 may determine that the timeline for PUSCH scheduling is not satisfied in step S180. In step S182, the WD 22 may then drop the earlier signal (PUCCH in this example) and transmit, such as via radio interface 82, the latter signal (PUSCH in this example).

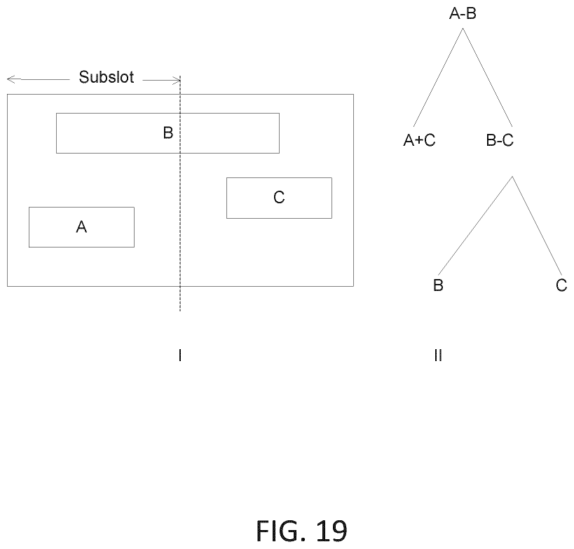

Priority based resolution may also be considered in some embodiments. In some embodiments, a message can be any control or data type, other than just mentioned HARQ/PUCCH messages. Whenever a conflict happens, the WD 22 may check, such as via processing circuitry 84, the priority of interfering messages and may choose to transmit, such as via radio interface 82, the interfering message(s) with highest priority, and drop relatively low priority messages, i.e., messages with a priority below a predetermined threshold. There may be a situation with three or more messages interfering at the same time, or at different times such that resolution of a last message can depend on the initial conflicting pair. See FIG. 19 for example, where three outcomes (shown as a tree) can be realized depending of their priorities. These participating interfering messages may be called a Conflict Group where the resolution of the last message depends on the resolution of first message with time progression. In the example shown in FIG. 19, a WD 22, such as via, for example, processing circuity 84, first resolves the conflict between message A and B, then the WD 22 resolves the conflict between the outcome message and message C. Table 1 details various example outcomes subject to the messages' priorities.

TABLE 1

| Message | Priority | | | | | |
|---|---|---|---|---|---|---|
| A | High | Medium | High | Low | Medium | Low |
| B | Medium | Low | Low | Medium | High | High |
| C | Low | High | Medium | High | Low | Medium |

| | | | |
|---|---|---|---|
| Conflict | A, C | C | B |
| resolution | | | |

In Table 1, all messages have different priorities, but there may be cases where the messages may have the same priority, in which case the conflict resolution may be applied randomly between the same priority messages or the WD 22 may itself (e.g., independently and not based on a predetermined/predefined rule know to WD 22 and network node 16) prioritize the messages (if explicit priority is not equipped), e.g., based on one or more parameters or conditions, such as, for example, signal-to-interference-plus-noise-ratio (SINR), success probability of the message, capacity, message size, etc.

The priority may be communicated explicitly (while allocating resource), or assessed based on message resource-mapping, etc. Network node 16 may establish traffic classes, and associate priorities based on the required success rate or reliability for a given message belonging to a traffic class. For, e.g., URLLC traffic 99.99% with highest priority and eMBB with 90% block error rate (BLER) with lowest priority.

Another embodiment of conflict resolution may include taking account of utility maximization of the conflict group. Consider FIG. 19, for example, with message A having a medium priority, message B having high priority, i.e., a priority higher than the priority of message A and/or based on some predetermined priority level, and message C having medium priority, i.e., a priority lower than the priority of message B and/or based on some predetermined priority level. These priorities may be translated into some utility function; see Table 2 for example. In Table 3, an outcome is shown which is the opposite of Table 1, where those messages are favored which maximizes the conflict group utility.

TABLE 2

| | | | |
|---|---|---|---|
| Message | A | B | C |
| Priority | Medium | High | Medium |
| Expressing priority | 2 | 3 | 2 |
| as a utility (high is | | | |
| priority, then high | | | |
| is the utility) | | | |

TABLE 3
All possible outcomes

| | B | A, C |
|---|---|---|
| Sum utility | 3 | 4 |

| | |
|---|---|
| Comment | Even though message B has the highest priority, its |
| | utility is lesser than sum utility of success of other two |
| | relatively low priority messages, hence with given |
| | utility function, for the conflict resolution of messages |
| | in the group, those messages should be favored which |
| | maximizes the conflict group utility. |

Further, the time (or conflict) window of resolution can be static or dynamic. The size may be for example:
Fixed window of, e.g.:
   Subslot;
   Slot;
   Superframe; or
   Fixed number of x slots, or fixed time window t.
Dynamic window with, e.g.:
   first n conflicts (e.g., in FIG. 19, there are two conflicts, between Message A and B; and between Message B and C); or
   Time window equivalent to time period of conflict group (which can span over large number of than subslots or slots).

Further, the conflict resolution may be applied in the direction of:
Uplink (UL);
   E.g., WD 22, such as via processing circuitry 84 and/or radio interface 82, performs conflict resolution for its interfering UL messages according to any of the embodiments described herein (and the network node 16 receives such messages accordingly);
Downlink;
   E.g., network node 17 (e.g., gNB), such as via processing circuitry 68 and/or radio interface 62, performs conflict resolution for its interfering DL messages according to any of the embodiments described herein (and the WD 22 receives such messages accordingly);
Sidelink;
   E.g., in device-to-device (D2D), a WD 22 performs conflict resolution for its interfering sidelink messages;
Combination of above;
   E.g., a WD 22 has both sidelink and UL messages conflicting in some time window.

Further, the intended receiver of messages can be a single node or multiple nodes., e.g.:
For the UL, different messages can be intended for different network nodes 16 (network nodes 16 acting as, for example, gNBs), or network nodes 16 and other WD(s) 22 (as D2D link), or relay nodes (network nodes 16 acting as relay nodes), etc.;
In case DL, different messages can be for a same WD 22, or different WDs 22, or any different type of participating nodes;
Similarly, a D2D WD 22 may have intended (conflicting) messages for multiple WDs 22 and network node 16 (e.g., gNB).

Further the messages can be control messages (e.g., PUCCH or PDCCH or sidelink control channel/SLCCH) or data channels (e.g., PUSCH or PDSCH or sidelink shared channel/SLSCH) or a combination of both (data and control, e.g., SLSCH resource is interfering with a PUCCH resource, or a PUCCH resource is interfering with a PUSCH resource in UL).

According to one aspect, a network node configured to communicate with a wireless device (WD) 22 is provided. The network node has processing circuitry 68 configured to: receive a PUCCH resource from the WD 22; and signal a PUCCH resource indicator in a downlink control information, DCI, message so that a new PUCCH resource does not overlap with another PUCCH resource. According to another aspect, a method implemented in a network node is provided. The method includes receiving a PUCCH resource from the WD 22; and signaling a PUCCH resource indicator in a downlink control information, DCI, message so that a new PUCCH resource does not overlap with another PUCCH resource.

According to yet another aspect, a wireless device (WD 22) configured to communicate with a network node 16, the WD 22 having processing circuitry 84 configured to: remove a candidate physical uplink control channel, PUCCH, resource from a first subslot that extends to a next subslot; or remove a candidate physical uplink control channel, PUCCH, resource from the next sublot that overlaps with a PUCCH extending from the first subslot to the next subslot.

According to this aspect, in some embodiments, upon removal, a PUCCH resource in the first subslot is selected. In some embodiments, an uplink control information, UCI, message with a first priority is retained for transmission and a UCI having a priority lower than the first priority is discarded.

According to yet another aspect, a method implemented in a wireless device (WD 22). The method includes removing a candidate physical uplink control channel, PUCCH, resource from a first subslot that extends to a next subslot; or removing a candidate physical uplink control channel, PUCCH, resource from the next sublot that overlaps with a PUCCH extending from the first subslot to the next subslot.

According to this aspect, in some embodiments, upon removal, a PUCCH resource in the first subslot is selected. In some embodiments, an uplink control information, UCI, message with a first priority is retained for transmission and a UCI having a priority lower than the first priority is discarded.

Embodiment A1. A network node configured to communicate with a wireless device (WD), the network node configured to, and/or comprising a radio interface and/or comprising processing circuitry configured to:
receive a PUCCH resource from the WD; and
signal a PUCCH resource indicator in a downlink control information, DCI, message so that a new PUCCH resource does not overlap with another PUCCH resource.

Embodiment B1. A method implemented in a network node, the method comprising:
receiving a PUCCH resource from the WD; and
signaling a PUCCH resource indicator in a downlink control information, DCI, message so that a new PUCCH resource does not overlap with another PUCCH resource.

Embodiment C1. A wireless device (WD) configured to communicate with a network node, the WD configured to, and/or comprising a radio interface and/or processing circuitry configured to:
remove a candidate physical uplink control channel, PUCCH, resource from a first subslot that extends to a next subslot; or
remove a candidate physical uplink control channel, PUCCH, resource from the next sublot that overlaps with a PUCCH extending from the first subslot to the next subslot.

Embodiment C2. The WD of Embodiment C1, wherein, upon removal, a PUCCH resource in the first subslot is selected.

Embodiment C3. The WD of Embodiment C1, wherein an uplink control information, UCI, message with a first priority is retained for transmission and a UCI having a priority lower than the first priority is discarded.

Embodiment D1. A method implemented in a wireless device (WD), the method comprising:
removing a candidate physical uplink control channel, PUCCH, resource from a first subslot that extends to a next subslot; or
removing a candidate physical uplink control channel, PUCCH, resource from the next sublot that overlaps with a PUCCH extending from the first subslot to the next subslot.

Embodiment D2. The method of Embodiment D1, wherein, upon removal, a PUCCH resource in the first subslot is selected.

Embodiment D3. The method of Embodiment D1, wherein an uplink control information, UCI, message with a first priority is retained for transmission and a UCI having a priority lower than the first priority is discarded.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object-oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| | |
|---|---|
| Abbreviation | Explanation |
| eMBB | enhanced Mobile BroadBand |
| LTE | Long Term Evolution |
| NR | Next Radio |
| PUCCH | Physical Uplink Control Channel |
| PUSCH | Physical Uplink Shared Channel |
| SR | Scheduling Request |
| URLLC | Ultra-Reliable Low Latency Communication |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method implemented in a wireless device, WD, the method comprising:
removing a candidate physical uplink control channel, PUCCH, resource from a subslot to resolve an overlap of PUCCH resources in a slot, the candidate PUCCH resource extending from a next subslot and overlapping with a PUCCH resource extending from a first subslot to the next subslot, and removing the candidate PUCCH resource comprises removing the candidate PUCCH resource extending from the next subslot that overlaps with the PUCCH resource extending from the first subslot to the next subslot.

2. (canceled)

3. (canceled)

4. The method of claim 1, further comprising:
selecting a PUCCH resource to transmit at least one uplink control information, UCI, message in a first subslot; and
wherein the candidate PUCCH resource extends from a next subslot and removing the candidate PUCCH resource comprises removing the candidate PUCCH resource extending from the next subslot based at least in part on the PUCCH resource selected in the first subslot.

5. The method of claim 4, wherein removing the candidate PUCCH resource comprises removing the candidate PUCCH resource extending from the next subslot that overlaps with the selected PUCCH resource in the first subslot.

6. (canceled)

7. The method of claim 1, further comprising:
determining whether a WD processing timeline for an uplink control information, UCI, message multiplexing with a physical uplink shared channel, PUSCH, is satisfied, the resolution of the overlap being based at least in part on the determination.

8. The method of claim 7, further comprising one of:
based at least in part on the determination, multiplexing the UCI message on a physical uplink shared channel, PUSCH;
based at least in part on the determination, retaining a latter one of the PUSCH and the UCI message for transmission and discarding an earlier one of the PUSCH and the UCI message; and
based at least in part on the determination, retaining one of the PUSCH and UCI for a transmission having a first priority and discarding the other one of the PUSCH and UCI message having a priority lower than the first priority.

9. The method of claim 1, wherein an uplink control information, UCI, message with a first priority is retained for transmission and a UCI message having a priority lower than the first priority is discarded.

10. The method of claim 1, wherein the resolution of the overlap is based at least in part on a relative priority associated with each uplink control information, UCI, message to be transmitted in the overlapping PUCCH resources in the slot and a utility maximization function.

11. A method implemented in a network node, the method comprising:
receiving a physical uplink control channel, PUCCH, transmission, a PUCCH resource used for the PUCCH transmission being based at least in part on a removal of a candidate PUCCH resource from a subslot to resolve an overlap of PUCCH resources in a slot the PUCCH resource used for the PUCCH transmission being based at least in part on the removal of the candidate PUCCH resource extending from a next subslot that overlaps with a PUCCH resource extending from a first subslot to the next subslot.

12. (canceled)

13. (canceled)

14. The method of claim 11, wherein the PUCCH resource used for the PUCCH transmission is based at least in part on the removal of the candidate PUCCH resource extending from the next subslot based at least in part on a PUCCH resource selection in a first subslot.

15. The method of claim 11, wherein the PUCCH resource used for the PUCCH transmission is based at least in part on the removal of the candidate PUCCH resource extending from a next subslot that overlaps with a selected PUCCH resource in a first subslot.

16. (canceled)

17. The method of claim 11, wherein the PUCCH resource used for the PUCCH transmission is based at least in part on whether a wireless device, WD, processing timeline for an uplink control information, UCI, message multiplexing with a physical uplink shared channel, PUSCH, is satisfied.

18. The method of claim 17, wherein receiving the PUCCH transmission further includes one of:
based at least in part on whether the WD processing timeline for the UCI message multiplexing with the PUSCH is satisfied, receiving the PUCCH transmission as the UCI message being multiplexed on a physical uplink shared channel, PUSCH;
based at least in part on whether the WD processing timeline for the UCI message multiplexing with the PUSCH is satisfied, receiving the PUCCH transmission as a latter one of the PUSCH and the UCI message being retained for the transmission and an earlier one of the PUSCH and the UCI message being discarded; and
based at least in part on whether the WD processing timeline for the UCI message multiplexing with the PUSCH is satisfied, receiving the PUCCH transmission as one of the PUSCH and UCI being retained for the transmission having a first priority and the other one of the PUSCH and UCI message having a priority lower than the first priority being discarded.

19. The method of claim 11, wherein an uplink control information, UCI, message with a first priority is retained for the PUCCH transmission and a UCI message having a priority lower than the first priority is discarded.

20. The method of claim 11, wherein receiving the PUCCH transmission is based at least in part on a relative priority associated with each uplink control information, UCI, message to be transmitted in an overlapping PUCCH resource in the slot and a utility maximization function.

21. A wireless device, WD, configured to communicate with a network node, the wireless device comprising processing circuitry, the processing circuitry being configured to cause the wireless device to:
remove a candidate physical uplink control channel, PUCCH, resource from a subslot to resolve an overlap of PUCCH resources in a slot, the candidate PUCCH resource extending from a next subslot and overlaps with a PUCCH resource extending from a first subslot to the next subslot, and the processing circuitry is configured to cause the wireless device to remove the candidate PUCCH resource by being configured to cause the wireless device to remove the candidate PUCCH resource extending from the next subslot that overlaps with the PUCCH resource extending from the first subslot to the next subslot.

22. (canceled)

23. (canceled)

24. The wireless device of claim 21, wherein:
the processing circuitry is further configured to select a PUCCH resource to transmit at least one uplink control information, UCI, message in a first subslot; and
the candidate PUCCH resource extends from a next subslot; and
the processing circuitry is configured to cause the wireless device to remove the candidate PUCCH resource by being configured to cause the wireless device to remove the candidate PUCCH resource extending from the next subslot based at least in part on the PUCCH resource selected in the first subslot.

25. The wireless device of claim 24, wherein the processing circuitry is further configured to cause the wireless device to remove the candidate PUCCH resource extending from the next subslot that overlaps with the selected PUCCH resource in the first subslot.

26. (canceled)

27. The wireless device of claim 21, wherein the processing circuitry is further configured to cause the wireless device to:
determine whether a WD processing timeline for an uplink control information, UCI, message multiplexing with a physical uplink shared channel, PUSCH, is satisfied, the resolution of the overlap being based at least in part on the determination.

28. The wireless device of claim 27, wherein the processing circuitry is further configured to cause the wireless device to one of:
based at least in part on the determination, multiplex the UCI message on a physical uplink shared channel, PUSCH;
based at least in part on the determination, retain a latter one of the PUSCH and the UCI message for transmission and discard an earlier one of the PUSCH and the UCI message; and
based at least in part on the determination, retain a one of the PUSCH and UCI for transmission having a first priority and discard the other one of the PUSCH and UCI message having a priority lower than the first priority.

29. The wireless device of claim 21, wherein an uplink control information, UCI, message with a first priority is retained for transmission and a UCI message having a priority lower than the first priority is discarded.

30. The wireless device of claim 21, wherein the resolution of the overlap being based at least in part on a relative priority associated with each uplink control information, UCI, message to be transmitted in the overlapping PUCCH resources in the slot and a utility maximization function.

31. A network node configured to communicate with a wireless device, WD, the network node comprising processing circuitry, the processing circuitry configured to cause the network node to:
receive a physical uplink control channel, PUCCH, transmission, a PUCCH resource used for the PUCCH transmission being based at least in part on a removal of a candidate PUCCH resource from a subslot to resolve an overlap of PUCCH resources in a slot, the PUCCH resource used for the PUCCH transmission being based at least in part on the removal of the candidate PUCCH resource extending from a next subslot that overlaps with a PUCCH extending from a first subslot to the next subslot.

32. (canceled)

33. (canceled)

34. The network node of claim 31, wherein the PUCCH resource used for the PUCCH transmission is based at least in part on the removal of the candidate PUCCH resource extending from a next subslot based at least in part on a PUCCH resource selection in the first subslot.

35. The network node of claim 31, wherein the PUCCH resource used for the PUCCH transmission is based at least in part on the removal of the candidate PUCCH resource extending from the next subslot that overlaps with a selected PUCCH resource in the first subslot.

36. (canceled)

37. The network node of claim 31, wherein the PUCCH resource used for the PUCCH transmission is based at least in part on whether a wireless device, WD, processing timeline for an uplink control information, UCI, message multiplexing with a physical uplink shared channel, PUSCH, is satisfied.

38. The network node of claim 37, wherein the processing circuitry is configured to cause the network node to receive the PUCCH transmission by being configured to cause the network node to one of:
based at least in part on whether the WD processing timeline for the UCI message multiplexing with the PUSCH is satisfied, receive the PUCCH transmission as the UCI message being multiplexed on a physical uplink shared channel, PUSCH;
based at least in part on whether the WD processing timeline for the UCI message multiplexing with the PUSCH is satisfied, receive the PUCCH transmission as a latter one of the PUSCH and the UCI message being retained for the transmission and an earlier one of the PUSCH and the UCI message being discarded; and
based at least in part on whether the WD processing timeline for the UCI message multiplexing with the PUSCH is satisfied, receive the PUCCH transmission as one of the PUSCH and UCI being retained for the transmission having a first priority and the other one of the PUSCH and UCI message having a priority lower than the first priority being discarded.

39. The network node of claim 31, wherein an uplink control information, UCI, message with a first priority is retained for the PUCCH transmission and a UCI message having a priority lower than the first priority is discarded.

40. The network node of claim 31, wherein the processing circuitry is configured to cause the network node to receive the PUCCH transmission based at least in part on a relative priority associated with each uplink control information, UCI, message to be transmitted in an overlapping PUCCH resource in the slot and a utility maximization function.
